(19) United States
(12) Patent Application Publication
(10) Pub. No.: US 2005/0182920 A1
(43) Pub. Date: Aug. 18, 2005

(54) Apparatus and method for expedited exception handling using a dedicated port

(76) Inventor: Alexandre Palus, Houston, TX (US)

Correspondence Address: TEXAS INSTRUMENTS INCORPORATED, P O BOX 655474, M/S 3999, DALLAS, TX, 75265, US

(21) Appl. No.: 11/057,301

(22) Filed: Feb. 11, 2005

Related U.S. Application Data
(60) Provisional application No. 60/544,368, filed on Feb. 13, 2004.

(51) Int. Cl. G06F 7/38

(52) U.S. Cl. 712/244

(57) ABSTRACT

To expedite the response to an interrupt instruction, an interrupt identification component monitors the execution unit of the central processing unit. When an interrupt instruction is identified, the interrupt identification component forwards this information through a dedicated port to the exception handler, the exception handler storing the procedures that respond to the interrupt instruction. In response to the signals from the interrupt identification unit, the exception handler forwards the responsive procedure to the central processing unit. In this manner, the execution of the interrupt procedure is expedited.

This application claims priority under 35 USC §119(e)(1) of Provisional Application No. 60/544,368 (TI-37853PS) filed Feb. 13, 2004.

### BACKGROUND OF THE INVENTION

1. Field of the Invention

This invention relates generally to data processing systems and, more particularly, to the handling of software interrupt instructions. A technique for expedited handling of software interrupt instructions is described.

2. Background of the Invention

During the execution of a program by a central processing unit, a change in the program flow may be required. This change in the program execution is performed by an instruction referred to as an interrupt instruction. The execution apparatus in the central processing unit will process the interrupt instruction as an ordinary instruction. The interrupt instruction responds by identifying the new procedure and initiating the new procedure. The interrupt instruction will cause the central processing unit to branch to a specific table or vector table. The table contains a branch instruction to the exception handler or the address of the exception handler. The exception handler will generally identify the source of the software exception and then branch to the exception sub-routine.

Referring to FIG. 1, the process for handling interrupt instructions is illustrated. The memory unit 5 is coupled to the central processing unit 10. During the course of program execution, the memory unit 5 will transfer an interrupt instruction to the central processing unit. When an interrupt instruction is received central processing unit 10, the instruction will be processed by the execution unit 101. The interrupt instruction includes the address of the process for responding to the interrupt instruction. The central processing unit 10 typically includes a pipelined execution unit 101. The interrupt instruction is executed in the central processing unit 10 and the proper signals are applied to the address bus 12 and to the data bus 13, the data buses being coupled to the exception handler 15. The exception handler 15 stores the responsive procedures that respond to the identified interrupts. The procedure identified by the execution of the interrupt instruction is then transferred to the central processing unit 10 where the procedure is executed.

The presence of the pipelined execution unit 101 results in a delay of the execution of the interrupt pipelined instruction and the initiation of the new procedure.

A need has therefore been felt for apparatus and an associated method having the feature of being able to provide to expedite the execution of the software interrupt instruction. It would be yet another feature of the apparatus and associated method to identify an interrupt software instruction. It would be a still further feature of the apparatus and associated method to identify the software interrupt instruction. It would be a more particular feature of the apparatus and associated method to identify the software interrupt instruction with a hardware component. It is a still further feature of the apparatus and associated method to use the identity of the software instruction to access the procedure in the interrupt handler related to the software interrupt instruction. It is a still more particular feature of the apparatus and associated method to have a dedicated port to the central processing unit through which the signals from the hardware component and signals to the hardware component can be transmitted. It would be a still further particular feature of the present invention to have dedicated conducting paths from the exception handler to the execution unit of the central processing unit.

### SUMMARY OF THE INVENTION

The foregoing and other features are accomplished, according the present invention, by processing an interrupt instruction in an instruction stream in an expedited manner. The interrupt instruction is entered in the central processing unit for execution. In the central processing unit, the interrupt instruction execution unit identifies the interrupt instruction and signals the identity of the interrupt instruction to the interrupt handler, the storage unit containing the procedure to respond to the interrupt instruction, on a dedicated path. In response, the identified procedure is then transferred to the central processing unit by a dedicated path. In this manner the typical execution of the interrupt instruction is expedited because the interrupt does not have to be executed in the central processing unit pipeline.

Other features and advantages of present invention will be more clearly understood upon reading of the following description and the accompanying drawings and the claims.

### BRIEF DESCRIPTION OF THE DRAWINGS

FIG. 1 illustrates the execution of an interrupt instruction according to the prior art.

FIG. 2 illustrates the execution of an interrupt instruction according to the present invention.

### DESCRIPTION OF THE PREFERRED EMBODIMENT

1. Detailed Description of the Figures

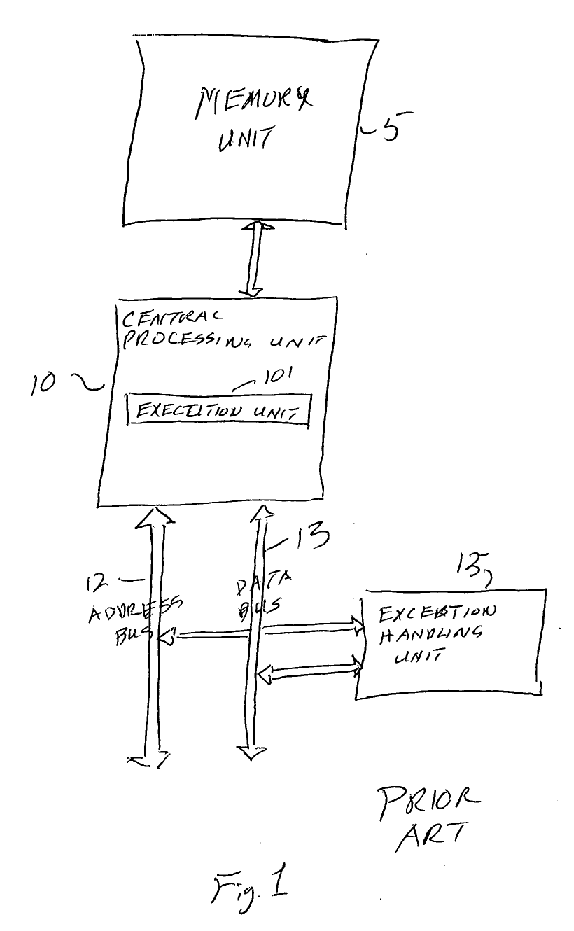

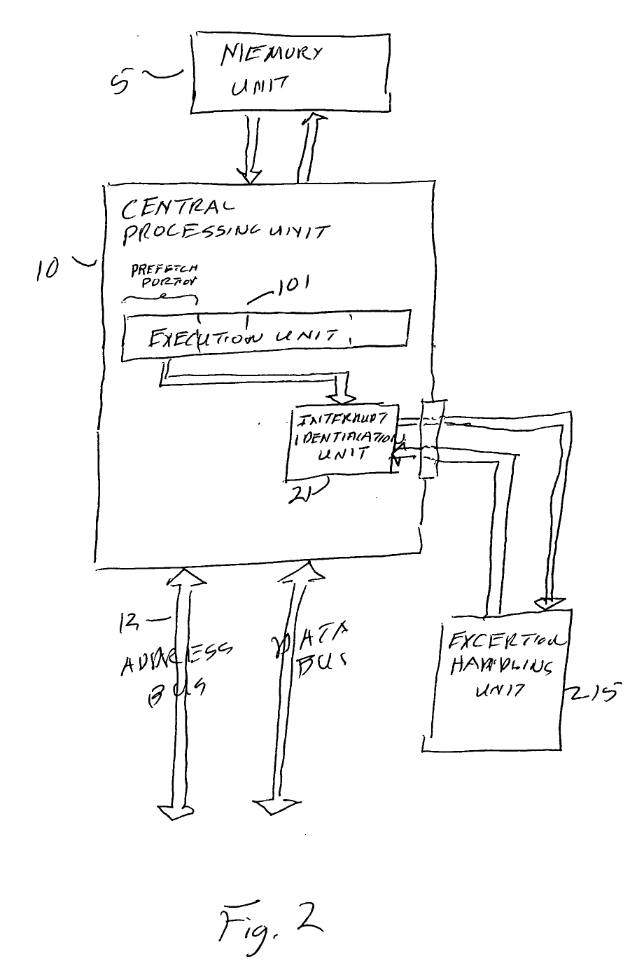

Referring now to FIG. 2, the execution of an interrupt instruction, according to the present invention, is shown. As in FIG. 1, memory unit 5 provides an instruction stream including the interrupt instruction. The interrupt instruction is entered in the pipelined execution unit 101 of the central processing unit. The pipelined execution unit 101 is monitored by an interrupt identification unit 21. In the preferred embodiment, the interrupt identification unit 21 is coupled to the first, pre-fetch stage of the execution unit 101. When an interrupt instruction is identified by the interrupt identification unit 21, the interrupt identification unit 21 sends a signal group specifying the particular procedure in the exception handling unit 15. The signal group is transmitted over conducting paths through a dedicated port to the exception handling unit 15. In response to the signals from the interrupt identification unit 21, the exception handler 15 begins transmission of the related procedure stored in the exception handler unit 15. The related, i.e. related to the interrupt instruction, procedure is the predetermined response to each specific type of interrupt instruction.

2. Operation of the Preferred Embodiment

As indicated in the foregoing description, the response to the interrupt instruction circumvents the execution delay resulting from the pipelined structure of the instruction in the central processing unit pipeline. Rather, the identification of the interrupt instruction by the (hardware-implemented) interrupt identification unit permits the immediate access to the exception handling unit. The transfer to the central processing unit of the responsive procedure expedites the response to interrupt condition. This procedure is expedited because the response to the presence of the presence of the interrupt instruction is immediate and not subject delay resulting from processing the instruction in the central processing unit pipeline. In addition, the dedicated port and the associated conducting paths further expedite the transfer of the procedure responsive to the interrupt instruction.

As will be clear to those skilled in the art, the memory unit 5 and the exception handling unit 15 can be the same storage device. It will also be clear that the maximum benefit from this device can be achieved when the interrupt identification unit is coupled to the first stage of the pipelined instruction unit, typically referred to a as the prefetch stage provides the

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

1. In a data processing unit, interrupt instruction execution apparatus, the apparatus comprising:
an exception handling unit, the exception handling unit storing procedures for responding to interrupt instructions;
a central processing unit including an execution unit; and
an interrupt identification unit coupled to the execution unit, the interrupt identification unit identifying an interrupt instruction and accessing the procedure in the exception handling related to the identified instruction.

2. The apparatus as recited in claim 1 further comprising a dedicated port, wherein the interrupt identification unit is coupled to the exception handling unit through a dedicated port.

3. The apparatus as recited in claim 1 wherein, in response to the access of the exception handling unit, the responsive procedure is forwarded to the execution unit.

4. The apparatus as recited in claim wherein the responsive procedures are transmitted to the execution unit through the dedicated port.

5. The apparatus as recite in claim 1 further comprising a memory unit, the memory unit storing the interrupt instruction, wherein memory unit and the exception handling unit are implemented in the same device.

6. The method for executing an interrupt instruction, the method comprising;
identifying an interrupt instruction by a hardware component coupled to an execution of central processing unit, accessing a responsive procedure in an exception handling unit by the hardware component; and
transferring the responsive procedure to the central processing unit to execute the interrupt instruction.

7. The method as recited in claim 5 wherein the transmission of signals accessing the responsive procedure in the exception handling unit is transferred through a dedicated port in the central processing unit.

8. The method as recited in claim 6 wherein the responsive procedure is transferred to the execution unit through the dedicated port.

9. The method as recited in claim 1 wherein the interrupt instruction is stored in a memory unit, the method further including implementing the memory unit and the exception handling unit in the same device.
